(19) United States
(12) Patent Application Publication
(10) Pub. No.: US 2012/0008050 A1
(43) Pub. Date: Jan. 12, 2012

(54) VIDEO PROCESSING APPARATUS AND VIDEO PROCESSING METHOD

(75) Inventor: Ryo Hirono, Kanagawa (JP)

(73) Assignee: SONY CORPORATION, Tokyo (JP)

(21) Appl. No.: 13/173,016

(22) Filed: Jun. 30, 2011

(30) Foreign Application Priority Data
Jul. 8, 2010 (JP) P2010-155600

(51) Int. Cl. H04N 5/14

(52) U.S. Cl. 348/671

(57) ABSTRACT

A video processing apparatus includes a property change acquisition unit for acquiring a change of a property of an input video, a video processing unit for performing video processing on the input video, a gain adjustment unit for adjusting a gain for the video processing, and a control unit for performing control to change a setting for the video processing in the video processing unit according to the property change of the input video and decrease a gain of the gain adjustment unit at a timing of changing the setting for the video processing.

### BACKGROUND

The present disclosure relates to a video processing apparatus and a video processing method.

In recent years, a function of automatically controlling image quality, as indicated by menu items such as “Auto” and “Intelligent,” for example, in video processing of a television receiver (TV), has been widely used.

Further, a technique for dynamically controlling a backlight according to an average screen brightness level and presence or absence of an OSD to thereby dynamically control image quality is disclosed in Japanese Patent Application Laid-open Publication No. 2008-299191.

### SUMMARY

In automatic control of image quality, control that is optimal for a video scene, for example, by dynamically changing an image quality control process into a suitable mode or setting, is performed using video-related information or a result of analyzing a video signal. For example, an image quality processing setting is optimized according to a type of content such as sports, cinema, and animation or contrast processing is controlled by a brightness distribution of a video signal. Further, control for changing a setting for a signal enhancement process such as sharpness by a frequency distribution state of the video is performed.

However, in this case, when the video processing mode or setting is automatically switched, the image quality is rapidly changed. The change of the image quality is visible, as any abnormal state in the video, to a viewer. For example, in video processing such as sharpness (an edge enhancement process), when a sharpness gain is gradually changed, the change of the video is relatively difficult to recognize with the naked eye, but a contour of the video is rapidly changed when a change of a filter factor is performed. Thereby, the video visible to the viewer is rapidly changed, which may be recognized as an uncomfortable feeling by the viewer.

Meanwhile, in order to resolve this problem, for example, a technique of switching a mode or performing setting change within such a range that it is difficult for a viewer to identify has been considered. However, in this method, it is necessary to decrease a mode or setting change level. Thereby, it is difficult to typically perform optimal control on video scenes that are changed from moment to moment.

The present disclosure is made in view of the above-mentioned issue, and it is desirable to provide a video processing apparatus and a video processing method which are novel and improved and capable of changing a setting of video processing without giving a user an uncomfortable feeling when a property of an input video is changed.

According to an embodiment of the present invention, there is provided a video processing apparatus includes a property change acquisition unit for acquiring a change of a property of an input video, a video processing unit for performing video processing on the input video, a gain adjustment unit for adjusting a gain for the video processing, and a control unit for performing control to change a setting for the video processing in the video processing unit according to the property change of the input video and decrease a gain of the gain adjustment unit at a timing of changing the setting for the video processing.

In this configuration, the control unit sets the gain of the gain adjustment unit to 0 at the timing of changing the setting for the video processing to make the video processing in the video processing unit inactive.

In this configuration, the control unit sets the gain of the gain adjustment unit to 0 during a predetermined period of time including the timing of changing the setting for the video processing to make the video processing in the video processing unit inactive.

In this configuration, the control unit decreases the gain of the gain adjustment unit to 0 before the predetermined period of time and increases the gain of the gain adjustment unit after the predetermined period of time elapses.

In this configuration, the control unit changes the setting of the video processing in the video processing unit in stages according to the property change of the input video.

According to another embodiment of the present invention, there is provided a video processing method includes acquiring a change of a property of an input video, performing video processing on the input video, changing a setting for the video processing according to the property change of the input video, and decreasing a gain for the video processing at a timing of changing the setting for the video processing.

In this configuration, the decreasing of the gain for the video processing includes decreasing the gain to 0 to make the video processing inactive.

In this configuration, the decreasing of the gain for the video processing includes setting the gain for the video processing to 0 during a predetermined period of time including the timing of changing the setting for the video processing.

In this configuration, the decreasing of the gain for the video processing includes decreasing the gain to 0 before the predetermined period of time and increasing the gain after the predetermined period of time elapses.

In this configuration, the changing of the setting for the video processing includes changing the setting for the video processing in stages according to the property change of the input video.

According to the embodiments of the present disclosure described above, it is possible to change a video processing setting without giving a user an uncomfortable feeling when a property of an input video is changed.

### BRIEF DESCRIPTION OF THE DRAWINGS

FIG. 1 is a schematic diagram showing an example of a configuration of a video processing apparatus according to one embodiment of the present disclosure;

FIG. 2 is a property diagram showing frequency properties of input signals I of a video having no high frequency signal and a video having a high frequency signal;

FIG. 3 is a timing chart showing an example in which a gain is gradually changed before and after setting change timing when a setting of a filter factor is changed;

FIG. 4 is a timing chart showing a process according to the present embodiment; and

FIG. 5 is a timing chart showing an example in which a filter setting is gradually changed in an inactive period.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Also, a description will be given in the following order.

1. Example of Configuration of Video Processing Apparatus

2. Example of Control when Frequency Property of Video is Changed

3. Example of Process in Present Embodiment

### 1. Example of Configuration of Video Processing Apparatus

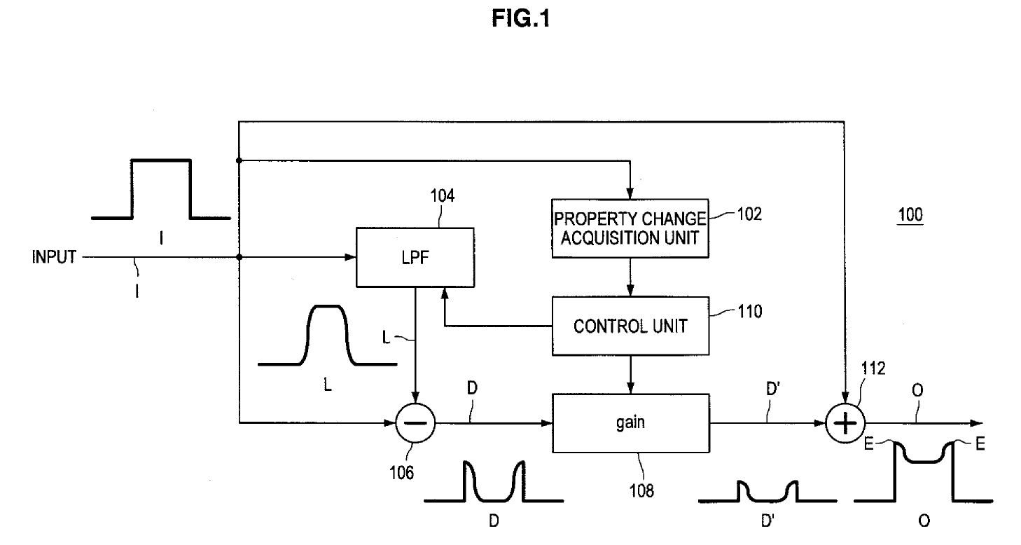

First, an example of a configuration of a video processing apparatus 100 according to one embodiment of the present disclosure will be described with reference to FIG. 1. FIG. 1 is a block diagram showing the configuration of the video processing apparatus 100. The video processing apparatus 100 is, for example, included in a device such as a television receiver. As shown in FIG. 1, the video processing apparatus 100 includes a property change acquisition unit 102, a low pass filter 104, a subtraction unit 106, a gain adjustment unit 108, a control unit 110, and an addition unit 112.

In the present embodiment, when video processing content including rapid change in a video is changed, video processing is performed to control processing intensity such as a level of a signal of the video or a gain so that the change does not stand out. Hereinafter, a sharpness process (edge enhancement process) will be described by way of example, but the present disclosure is not limited thereto. For example, the present disclosure may be applied to other video processing such as noise reduction processing, and various video processing switching such as switching between various automatic image quality control modes described above. In FIG. 1, an example in which the present embodiment is applied to an example of a sharpness process for a one-dimensional signal is shown.

First, a basic flow of a sharpness process in the configuration shown in FIG. 1 will be described. For explanation, in FIG. 1, signal waveforms I, L, D, D′ and O in respective steps are schematically shown in a block diagram. An input signal I shown in FIG. 1 represents, for example, an area in which signal intensity is high in the video and an adjacent area in which signal intensity is low. A sharpness process of enhancing an edge of a boundary between the area in which signal intensity is high and the area in which signal intensity is low will be described herein.

The input signal I is input to the subtraction unit 106 directly and via the low pass filter 104. As shown in FIG. 1, an output waveform L from the low pass filter 104 has a signal waveform having a rounded edge portion because a high band component is removed.

The subtraction unit 106 calculates a difference D between the input signal I and the output L of the low pass filter 104 and inputs the difference D to the gain adjustment unit 108. As shown in FIG. 1, the difference D becomes a signal having an enhanced edge portion. The gain adjustment unit 108 performs gain adjustment for the difference D and outputs a difference D′. The difference D′ is input to the addition unit 112. The addition unit 112 adds the difference D′ subjected to the gain adjustment to the input signal I, and outputs an output O. Thus, it is possible to perform an edge enhancement process (contour enhancement process) by increasing signal intensity of portions of edges E of the output O as shown in FIG. 1.

While the example of the sharpness process is illustrated in FIG. 1 as described above, the present embodiment may be applied to a wide variety of video processing. In the case of the sharpness process shown in FIG. 1, a video processing unit for performing the sharpness process is configured of the low pass filter 104, the subtraction unit 106, the gain adjustment unit 108, and the addition unit 112. Here, a video processing unit for performing processes other than the sharpness process may be controlled by the control unit 110. In this case, a gain of the video processing unit may be adjusted by control of the control unit 110.

In the above process, a frequency property of the input signal I may greatly differ according to content of the video signal. An example of a format of an input of a digital television broadcast to a television receiver (TV) includes a 1080i format with horizontal resolution of 1080 pixels.

Meanwhile, there is a signal that is input from external input terminals, such as a high-definition multimedia interface (HDMI) terminal or component terminals, to a TV. One such signal is a signal that is input with horizontal resolution of 1920 pixels (dots) from a Blu-ray disk player. Others include a terrestrial digital broadcasting video having horizontal resolution of 1440 pixels, a DVD video signal having horizontal resolution of 720 pixels, and a video signal obtained by up-converting, for example, a low resolution IPTV video.

The video signals are lower frequency signals in order of the signal having horizontal resolution of 1920 pixels, the signal having horizontal resolution of 1440 pixels, the signal having horizontal resolution of 720 pixels, and the signal obtained by up-converting a low resolution video. Videos having respective formats have different frequency properties. Switching between up-converted video and non-up-converted video often occurs irrespective of input switching by a user or may occur irrespective of a user's intention. Similarly, even when the up-converted video is being displayed, switching to resolution of an original video occurs without input switching by the user. For example, a change of a scene from an “advertisement” to a “broadcasting program” or a change of a scene from a “studio video of a broadcasting program” to a “live video” corresponds to such switching. Thus, the frequency property of the video greatly fluctuates constantly and iteratively.

As described above, since videos in various signal bands are input to the video processing apparatus 100, for example, included in a TV, it is preferable to change a process according to the frequency property in order to perform an appropriate sharpness process on various input signals I.

### 2. Example of Control When Frequency Property of Video is Changed

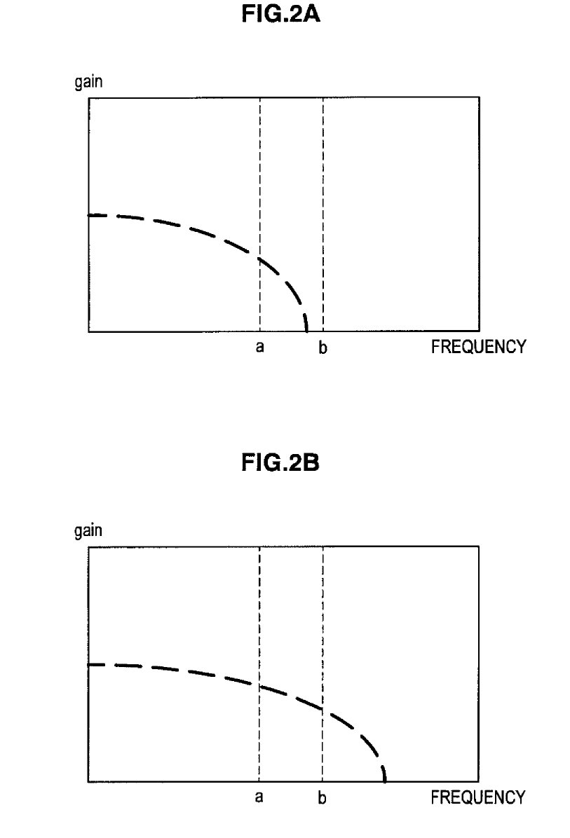

For example, FIG. 2 shows an example of frequency properties of input signals I of a video having no high frequency signal (a high band signal) and a video having a high frequency signal. Here, FIG. 2(A) shows a frequency property of the video having no high frequency signal, such as a property of an SD video having quality corresponding to analog television broadcasting (SDTV). Meanwhile, FIG. 2(B) shows a frequency property of the video having a high frequency signal, such as a property of an HD video corresponding to quality of high definition television (HDTV, Hi-Vision) size.

Cutoff frequencies a and b as shown in FIGS. 2(A) and (B) are set by a filter factor of the low pass filter 104 in FIG. 1. In the video having a high frequency signal as shown in FIG. 2(B), it is effective to separate a low frequency signal at the cutoff frequency b and a sharpness process is performed. In this case, it is assumed that the frequency property of the video is switched from the property of FIG. 2(B) to the property of FIG. 2(A) as described above. When the video shown in FIG. 2(A) is processed with the same filter factor to separate a low frequency signal at the cutoff frequency b, there is no high frequency signal in the video shown in FIG. 2(A). Thereby, desired effects of the sharpness process are not obtained and adverse effects appear in that noise is enhanced. Accordingly, an uncomfortable feeling may be given to a user who is viewing the video.

Thereby, for example, when switching to the video having the property shown in FIG. 2(A) occurs, a change into a filter factor corresponding to the cutoff frequency a is considered. When the cutoff frequency is changed from b to a, the gain in the gain adjustment unit 108 is correspondingly changed. In this case, before and after a setting of the filter factor is changed, the gain in the gain adjustment unit 108 is gradually changed over time for a desired filter setting so that a rapid video change is invisible to the viewer when the setting for the video processing is changed.

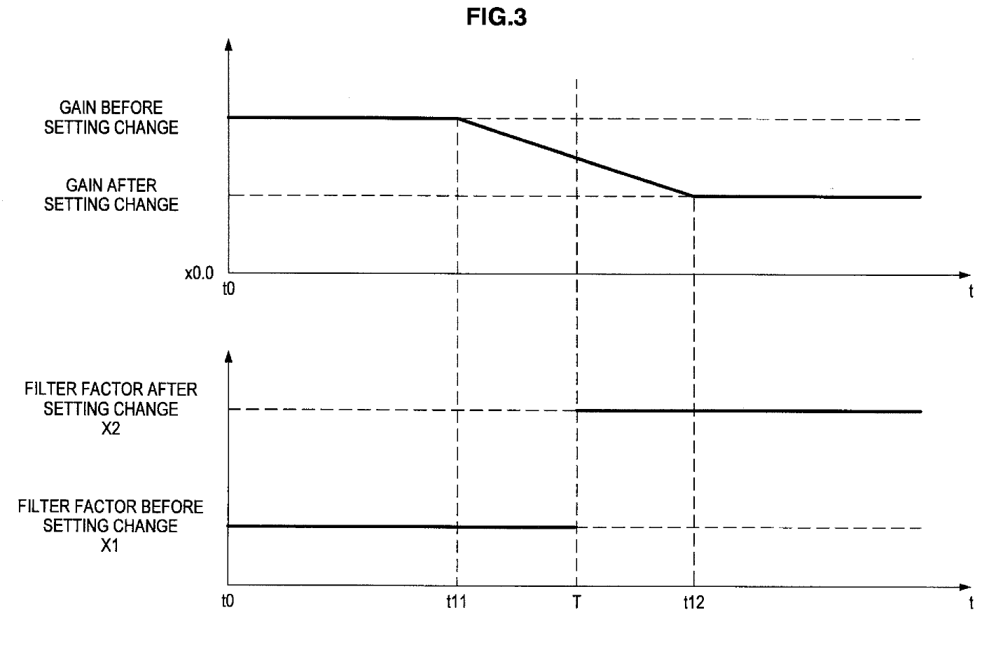

FIG. 3 shows an example in which the gain is gradually changed before and after timing for a setting change when the setting of the filter factor is changed. A horizontal axis indicates time t. When switching occurs from the property of FIG. 2(B) to the property of FIG. 2(A), a filter setting X1 of a vertical axis of FIG. 3 corresponds to the filter factor b, and a filter setting X2 corresponds to the filter factor a. Further, a gain before setting change on the vertical axis of FIG. 3 corresponds to a gain before filter factor change in the gain adjustment unit 108, and a gain after the setting change corresponds to a gain after filter factor change in the gain adjustment unit 108. In the example of FIG. 3, when the setting for the video processing is changed at time T, the gain of the gain adjustment unit 108 is gradually changed to decrease the gain before setting change from time t11 to reach the gain after setting change at time t12 after time T.

However, at a moment when the filter factor of the sharpness process is changed, a contour of the video is rapidly changed and an uncomfortable feeling is given to a user. Thereby, even when the gain is gradually changed as shown in FIG. 3, it is easily recognized as an uncomfortable feeling for the viewer.

When the gain of the gain adjustment unit 108 is 0, the difference D′ shown in FIG. 1 becomes 0 and the output O from the addition unit 112 becomes the same signal as the input signal I. Accordingly, when the gain of the gain adjustment unit 108 is 0, the sharpness process enters an inactive state and is not performed. In FIG. 3, the gain is gradually changed before and after the filter factor setting is changed. However, since the gain value is not 0 and the sharpness process works, a rapid change appears in the video at the moment when the filter factor for the sharpness process is changed.

Thereby, in the present embodiment, a technique of setting a period of time in which a parameter corresponding to video processing intensity is put in a through (inactive) state and changing a parameter giving a rapid change to a video in changing a filter setting or switching a process mode during the period of time is used. Accordingly, it is possible to perform optimal image quality setting without causing an uncomfortable feeling in the video.

### 3. Example of Process in Present Embodiment

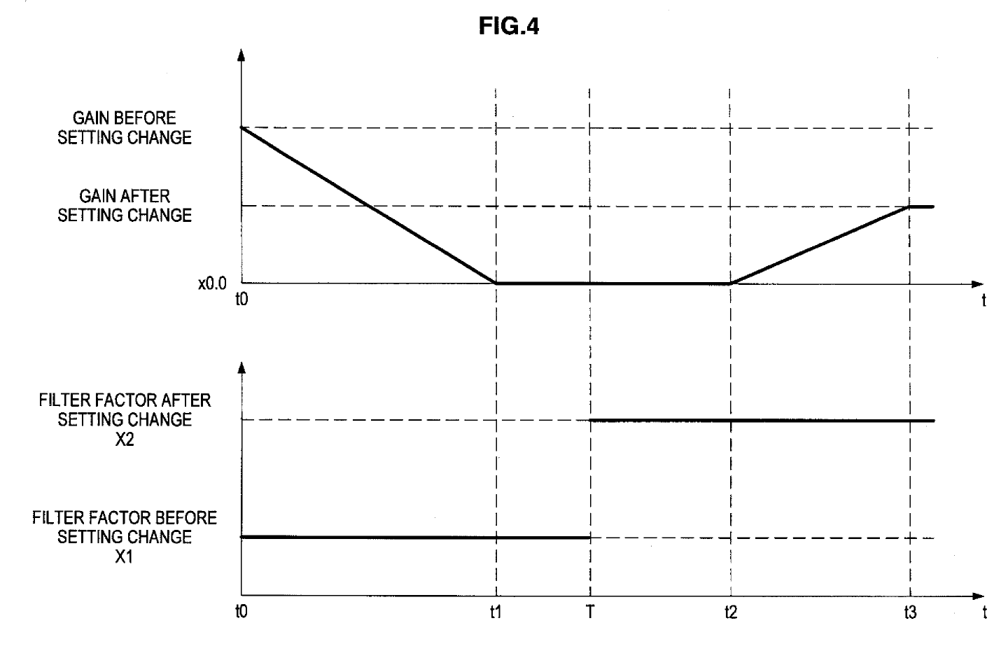

FIG. 4 is a timing chart showing a process according to the present embodiment. In FIG. 4, a horizontal axis indicates time t and a parameter of a vertical axis is the same as in FIG. 3. In FIG. 4, control of changing a process setting from a time when a state of a video is changed (time t0) is shown. Here, the property change acquisition unit 102 having received the input signal I judges whether the state of the video is changed. The property change acquisition unit 102 may judge whether the state of the video is changed, based on, for example, a histogram of a frequency property of the input signal I. Further, the property change acquisition unit 102 acquires content information, metadata and the like of the video together with the input signal I, and may acquire a change of a video state such as a change of a scene from an “advertisement” to a “broadcasting program” or a change of a scene from a “studio video of a broadcasting program” to a “live video,” which has been described above.

When it is detected by the property change acquisition unit 102 that the state of the video has been changed, detection information is sent to the control unit 120. When the state of the video is changed, the control unit 120 changes the setting of the filter factor of the low pass filter 104, and controls the gain of the gain adjustment unit 108. Specifically, first, control to gradually decrease the gain from the gain before setting change is performed between time t0 and time t1. The gain at time t1 is 0.0 times (×0.0) and the sharpness process is in an inactive state. Thereafter, the gain is slowly controlled to increase the gain from time t2 and reach a desired gain filter setting (a gain after setting change) at time t3.

In this case, when the filter setting is switched from X1 to X2 at time T, where t1≦T≦t2, the sharpness process is in an inactive state between time t1 and time t2. Thereby, even when the filter setting of the low pass filter 104 is switched, an output component of the low pass filter 104 is not included in the output from the addition unit 112. Accordingly, when the filter setting is switched from X1 to X2, there is no change in the video. Thus, when the filter setting is switched from X1 to X2, it is possible to transition to an optimal filter setting without giving an uncomfortable feeling to a viewer.

Further, since the sharpness process is in an inactive state in the period between t1 and t2, the gain is changed in a period between t0 and t3, but a video state is considered to be temporarily changed correspondingly. For example, since the sharpness process enters an inactive state and is OFF, definition of the video is considered to be slightly degraded compared to the case in which the sharpness process is ON. Even in this case, the gain is changed during a certain time, for example, the gain is changed over several seconds gradually (in stages) in the period between t0 to t3, thereby preventing an uncomfortable feeling from being given to the user. Further, since it is directly after content of the input signal I of the video, such as the frequency property, is greatly changed, an uncomfortable feeling given to a user is minimized compared to a rapid change of a video when only the filter factor is changed.

Further, the number of setting change steps when the gain is gradually changed between t0 and t1 and between t2 and t3 has predetermined accuracy (several steps to tens of steps from change initiation to termination) so that the gain value is not rapidly changed. Accordingly, it is possible to reliably suppress the user from recognizing an uncomfortable feeling despite the gain change.

While in the above explanation, the filter factor for the sharpness process has been described by way of example, the change of the video is assumed to be visible to the user despite the setting change in the inactive period depending on a configuration of a video processing algorithm or process.

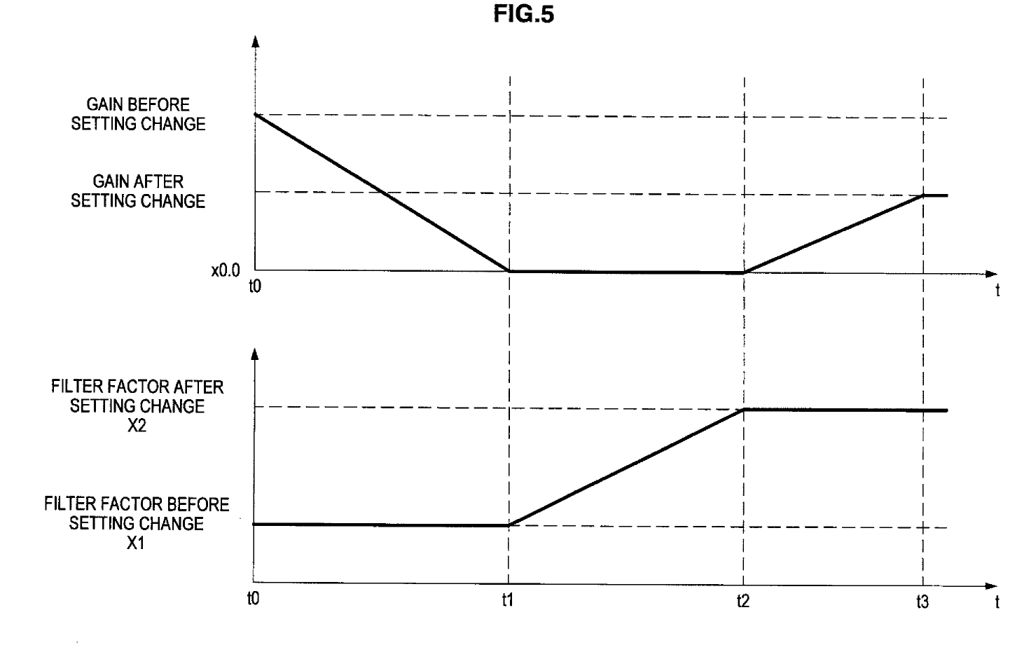

In this case, the filter setting may be gradually changed in the inactive period, as shown in FIG. 5. Further, when decrease of the gain to ×0.0 times greatly affects the video due to the configuration of the video processing algorithm or process, the gain may decrease to such an extent (e.g., ×0.5 times or ×0.2 times) that uncomfortable feeling is not given to the viewer instead of decreasing the gain to ×0.0 times.

According to the present embodiment as described above, it is possible to perform optimal video processing by switching video processing according to a state of an input video. In this case, it is possible to transition to an optimal process state without giving an uncomfortable feeling to the viewer by smoothly switching the mode and the setting.

Further, since the setting can be smoothly changed by putting the video processing intensity (gain) in the through state, the present disclosure may be applied to any video processing by adding only simple control software or hardware.

The preferred embodiments of the present disclosure have been described above with reference to the accompanying drawings, whilst the present disclosure is not limited to the above examples. A person skilled in the art may find various alternations and modifications within the scope of the appended claims, and it should be understood that they will naturally come under the technical scope of the present disclosure.

The present disclosure contains subject matter related to that disclosed in Japanese Priority Patent Application JP 2010-155600 filed in the Japan Patent Office on Jul. 8, 2010, the entire content of which is hereby incorporated by reference.

What is claimed is:

1. A video processing apparatus comprising:
a property change acquisition unit for acquiring a change of a property of an input video;
a video processing unit for performing video processing on the input video;
a gain adjustment unit for adjusting a gain for the video processing; and
a control unit for performing control to change a setting for the video processing in the video processing unit according to the property change of the input video and decrease a gain of the gain adjustment unit at a timing of changing the setting for the video processing.

2. The video processing apparatus according to claim 1, wherein the control unit sets the gain of the gain adjustment unit to 0 at the timing of changing the setting for the video processing to make the video processing in the video processing unit inactive.

3. The video processing apparatus according to claim 2, wherein the control unit sets the gain of the gain adjustment unit to 0 during a predetermined period of time including the timing of changing the setting for the video processing to make the video processing in the video processing unit inactive.

4. The video processing apparatus according to claim 3, wherein the control unit decreases the gain of the gain adjustment unit to 0 before the predetermined period of time and increases the gain of the gain adjustment unit after the predetermined period of time elapses.

5. The video processing apparatus according to claim 1, wherein the control unit changes the setting of the video processing in the video processing unit in stages according to the property change of the input video.

6. A video processing method comprising:
acquiring a change of a property of an input video;
performing video processing on the input video;
changing a setting for the video processing according to the property change of the input video; and
decreasing a gain for the video processing at a timing of changing the setting for the video processing.

7. The video processing method according to claim 6, wherein the decreasing of the gain for the video processing includes decreasing the gain to 0 to make the video processing inactive.

8. The video processing method according to claim 7, wherein the decreasing of the gain for the video processing includes setting the gain for the video processing to 0 during a predetermined period of time including the timing of changing the setting for the video processing.

9. The video processing method according to claim 8, wherein the decreasing of the gain for the video processing includes decreasing the gain to 0 before the predetermined period of time and increasing the gain after the predetermined period of time elapses.

10. The video processing method according to claim 6, wherein the changing of the setting for the video processing includes changing the setting for the video processing in stages according to the property change of the input video.
